(19) United States
(12) Patent Application Publication
(10) Pub. No.: US 2008/0031426 A1
(43) Pub. Date: Feb. 7, 2008

(54) Audio, video, and navigational law enforcement system and method

(76) Inventor: Walter L. Weeks, Marietta, GA (US)

Correspondence Address: Walter L. Weeks, 2445 Alexander Lake Drive SW, Marietta, GA, 30064, US

(21) Appl. No.: 11/821,249

(22) Filed: Jun. 22, 2007

Related U.S. Application Data
(60) Provisional application No. 60/816,439, filed on Jun. 27, 2006.

(51) Int. Cl. H04M 11/04

(52) U.S. Cl. 379/45

(57) ABSTRACT

A law enforcement recording system is implemented in hardware and software, providing GPS voice-command navigation to the 911 Call origin; a conference call between the 911 caller, 911 operator, and police officers; automatic data recording, including audio and video; and automatic generation of police reports.

### RELATED U.S. APPLICATION DATA

The present application claims priority to U.S. Provisional Application No. 60/816,439 filed Jun. 27, 2006, said prior applications being incorporated herein by reference in their entirety.

### FIELD OF THE INVENTION

This invention relates to the recording of law enforcement records, specifically a device to allow law enforcement personnel to listen in to a 911 call, navigate the officer to the location of the call, record audio and video of the encounter and client interview, and automatically file police reports.

### BACKGROUND OF THE INVENTION

Currently, law enforcement officers communicate with the dispatcher via conventional radio. The officer currently has information about the call only such that is relayed to the officer by the dispatcher. Directional information is also lacking, at the most officers are provided with an address or a map via their on-board laptop computers. Furthermore, officers have limited ability to record confrontations and interviews when away from their patrol car. Thus filling out incident reports can be time consuming and subject to errors in the officer's recollection or subjective interpretation.

### OBJECTS OF THE INVENTION

Therefore, it is an object of the invention to use a system such as Sprint GPS tracking of phone and Officer Location so the dispatcher can track location of all officers and dispatch the officer closest to the origin of a 911 call.

It is another object of the invention to use a device such as a Sprint Treo 650 cell phone equipped with a wireless blue tooth headset or other hands free device to patch the closest officer into a 911 call, allowing him to talk with the dispatcher and the caller.

It is another object of the invention to use a GPS device such as TomTom to provide audio navigational information in real time to the dispatched officer. TomTom will display visual navigational information on the officer's Treo as well as providing audio information, such as “Turn left, 100 yards, Turn left.”

It is another object of the invention to use a device such as the Sprint Treo 659 to capture audio and video footage of the encounter which can be used later as the police report in its entirety.

It is another object of the invention to use a device that has an on-board SD/Memory card with a capacity of at least 1 GB to store and transfer data from each work shift.

It is another object of the invention that the invention will automatically use audio and video data from the encounter to fill out police reports using MS Word and Excel, and used as evidence in the case that criminal charges are filed.

It is another object of the invention to increase performance of law enforcement personnel and provide more complete and accurate police reports. This has implications both for criminal investigations as well as public oversight of law enforcement.

It is another object of the invention to use a Secure Digital Point-to-Point communications protocol, because they are difficult for unauthorized parties to intercept.

It is another object of the invention to use a 12v power adapter to the phone and TomTom units while the officer is seated in the vehicle.

### BRIEF DESCRIPTION OF THE DRAWINGS

FIG. 1 illustrates the process of locating two patrol cars nearest the 911 call origin.

FIG. 2 illustrates the conference call between the 911 caller, the operator, and the two patrol cars.

FIG. 3 illustrates the process of sending GPS coordinates to patrol cars, which enables voice navigation to 911 call origin.

FIG. 4 illustrates the data items captured and stored.

FIG. 5 illustrates process of saving data and generating MS Word Reports.

FIG. 6 shows a typical smart phone.

FIG. 7 shows a typical blue tooth ear bud for use with a smart phone.

FIG. 8 shows an officer wearing the smart phone, GPS device, and blue tooth ear bud.

### DETAILED DESCRIPTION OF THE INVENTION

Implementation of the invention requires deployment of hardware and software. Required hardware consists of smart phones, such as but not limited to Treo 650s; GPS locators/navigation devices, such as but not limited to TomTom navigational devices, and a Bluetooth headset, also known as an ear bud. This hardware would be issued to law enforcement officers to wear on their person.

The software contains two modules, one is located at the 911 call center, and is custom-made for the purpose of locating patrol cars and sending them coordinates based on GPS locators. GPS mapping works using commercial off-the-shelf (COTS) products. The second module runs at the police precincts and generates reports, logs, data, and movies using office productivity software, such as but not limited to MS Office.

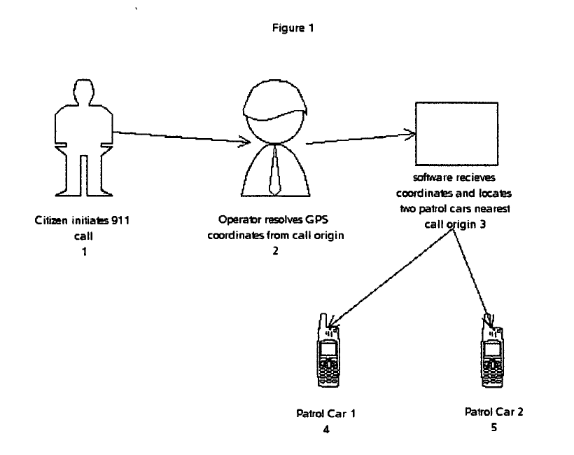

FIG. 1 shows the first step in the function of the law enforcement recording device. A citizen 1 initiates a 911 call from their home, office, or mobile phone. The 911 Operator 2 answers the call, while the invention computes the GPS coordinates of the call origin, and locates two patrol cars nearest the caller 3. The patrol cars 4, 5 receive the coordinates via SMS, or short messaging service. The patrol cars send their current position to the 911 call center via SMS every 10 minutes. The SMS service is available through wireless cell phone providers.

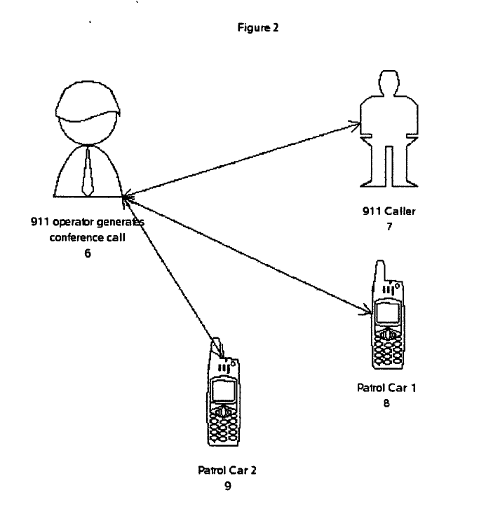

In FIG. 2, the 911 operator generates a conference call 6, with the 911 caller 7, as well as patrol cars one and two 8, 9. The conference call gives the officers and the 911 operator increased knowledge of what is happening at the scene. They can also give instructions to the caller, such as where to go or what to do to assist the officers or protect their safety. The software also records the conference call for possible use as evidence during criminal trial proceedings.

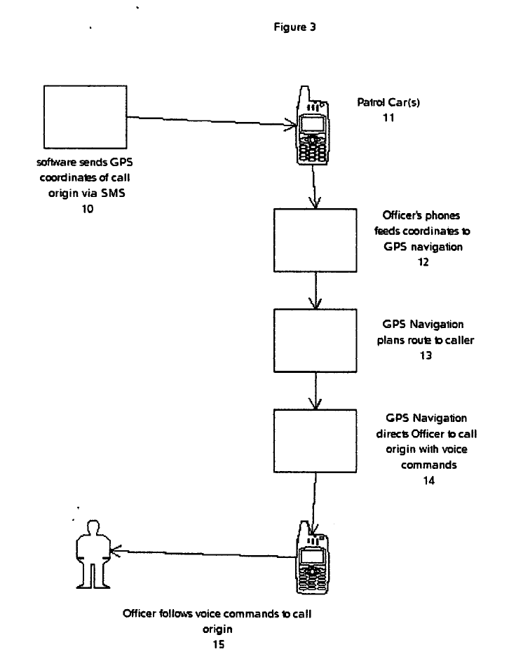

I FIG. 3, the software 10 sends GPS coordinates of the call location to the nearest patrol 11 cars via SMS. The officer's smart phone 12 receives the coordinates and transmits them via Bluetooth wireless link to the GPS navigational unit. Next, the GPS navigational unit plans a route to the 911 caller 13. The unit uses voice commands to direct the officer to the 911 caller 14. The officer follows the voice commands to the 911 call origin 15.

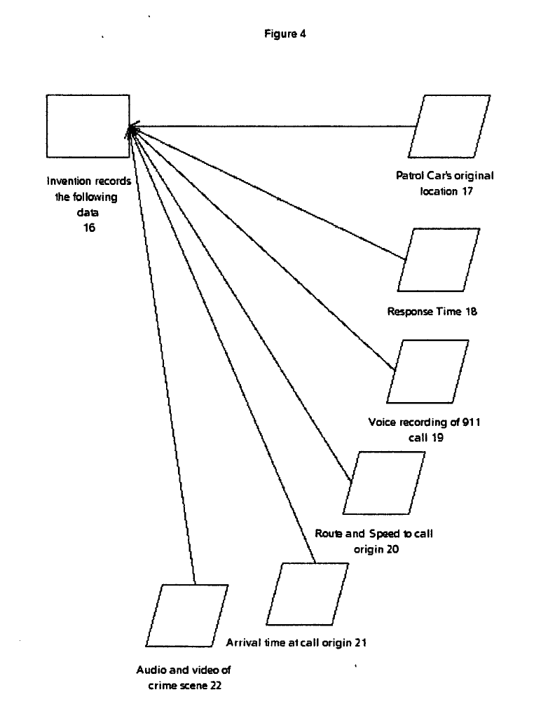

FIG. 4 shows the process of data capture and storage. The invention records several types of data 16 while the officer is on duty; this information is contained in the on-board storage of the smart phone, provided by a removable 2 GB SD card. First, the patrol car's original location at the time of the call is recorded 17. Next, the response time from the original location to the 911 call origin is recorded 18. The smart phone also makes an audio recording of the 911 conference call 19, featuring the 911 operator, the caller, and the officers dispatched. The phone captures route and speed to call origin 20, based on GPS information, followed by the arrival time at call origin 21. Finally, the smart phone captures a full audio and video recording of the crime scene 22, using the smart phone's built-in camera. The camera's video recorder automatically activates when the officer leaves the car. The smart phone's 2 GB SD card holds approximately 30 minutes of data.

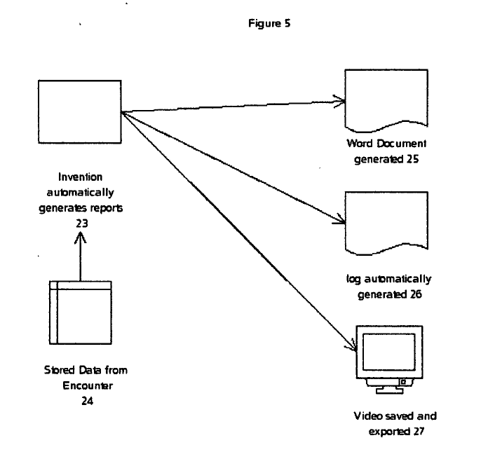

In FIG. 5, the officers return to the precinct at the end of the shift, remove the SD cards from their smart phones, and download their data 24 into the computer. Software residing on the precinct computers parses the data and automatically generates and files reports 23. The software generates text documents 25 using software such as Microsoft Word. Text for the report comes from audio recorded during the encounter, such as questioning of witnesses, etc. The software also fills out logs 26 according to pre-programmed standard formats. Finally, the audio and video from the encounter gets exported and saved into an independently-viewable format 27, such as a windows movie file. Reports can be uploaded to an intranet website for immediate download by authorized parties.

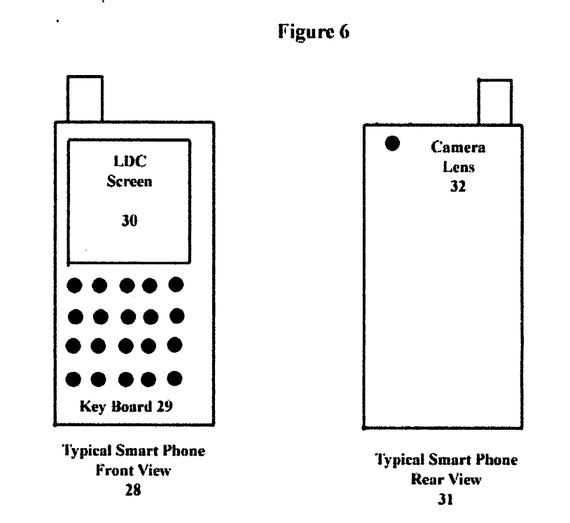

FIG. 6 shows a typical smart phone 28, such as but not limited to a Treo 650. The phone features a full miniature keyboard 29, and a large LCD screen 30. The rear-view of the phone 31 shows the on-board camera 32. These features are typical for most high-end smart phones.

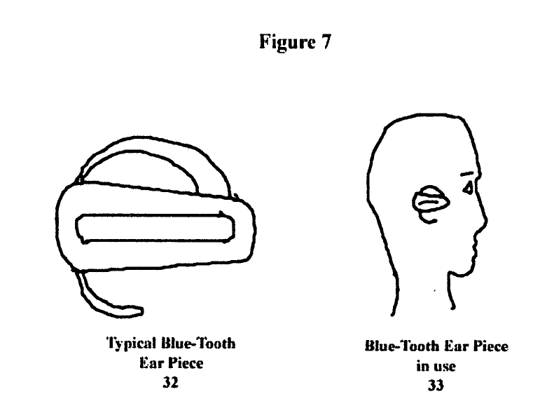

FIG. 7 shows a typical Bluetooth earpiece 32. The ear piece works with the phone over wireless Bluetooth, and transmits audio and voice from to the phone itself Bluetooth is advantageous because it leaves the officer's hands free, and it does not use wires, which could hinder the officer. The officer wears the ear piece as shown 33.

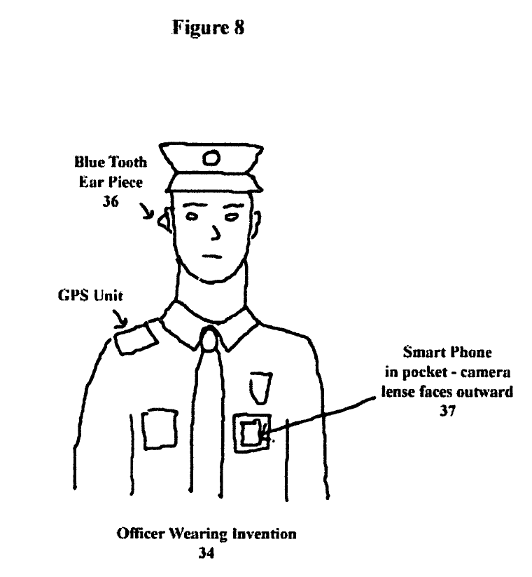

FIG. 8 shows an officer 34 wearing the equipment. The GPS unit 35 mounts on the officer's right epaulet. This allows the software to track the officer even when he leaves the patrol car. The officer can wear the ear piece 36 on the right or left; it should not interfere with headgear. Finally, the smart phone can be mounted in the officer's left breast pocket 37. The pocket can be modified to allow the camera lens to face outward with an unobstructed view.

Officers should receive a blank 2 GB SD card at the beginning of each shift. Any special orders or instructions for that shift are loaded onto the card. The invention is a unique system that allows enhanced information flow to and from officers in the field. This will increase officer response times and potentially save lives. In addition, it will increase the accuracy and ease of filing police reports, as well as gather critical evidence for criminal proceedings, leading to an increased convention rate and better public oversight.

All publications, patents and patent documents are incorporated by reference herein as though individually incorporated by reference. Although preferred embodiments of the present invention have been disclosed in detail herein, it will be understood that various substitutions and modifications may be made to the disclosed embodiment described herein without departing from the scope and spirit of the present invention as recited in the appended claims.

I claim:

1. A system of providing law enforcement officers real-time information about a 911 call, navigational information to call location, audio and video recording of an encounter with a 911 caller, and automated filing of police reports, comprising:
providing a means and apparatus for receiving in-bound 911 calls with operator, said 911 caller, and two closest law enforcement officers to said caller in conference mode,
providing a means and apparatus for determining the location of said law enforcement officers on patrol, and determining the two closest officers to said 911 caller,
providing a means and apparatus for transmitting GPS coordinates of said 911 caller to said law enforcement officers,
providing a means and apparatus for relating to said law enforcement officers audio navigational instructions to location of said 911 caller,
providing a means and apparatus for recording data such as but not limited to location of said law enforcement officers when call is received, route and speed taken to said 911 caller, time of arrival at said 911 caller's location, voice recording of said 911 call, and video of encounter with said 911 caller, providing a means and apparatus for automatically filing police reports from said data collected during said encounter with said 911 caller,
whereby said system provides real-time information to said law enforcement officers comprised of voice information from said 911 caller, voice navigational information to location of said 911 caller, audio and video recording of encounter with said 911 caller, as well as automatic generation of said police reports based on said recorded data.
